(19) United States
(12) Patent Application Publication
(10) Pub. No.: US 2026/0286746 A1
(43) Pub. Date: Sep. 24, 2026

(54) MULTIPOINT LOCK CASSETTE

(71) Applicant: Endura Products, LLC, Colfax, NC (US)

(72) Inventors: George E. HEID, Charlotte, NC (US); Austin Edwin MUNDY, Mount Airy, NC (US); Hilton A. BENNETT, Asheboro, NC (US)

(21) Appl. No.: 19/468,989

(22) Filed: Feb. 3, 2026

Related U.S. Application Data
(60) Provisional application No. 63/761,666, filed on Feb. 21, 2025.

(51) Int. Cl. E05B 63/14; E05B 63/00; E05B 63/08

(52) U.S. Cl. CPC E05B 63/14; E05B 63/0056; E05B 63/08

(57) ABSTRACT

A multipoint lock and cassette assembly therefore are described. The multipoint lock can include a replaceable cassette housing containing a spring force mechanism configured to bias a ball latch detent outwardly. The cassette assembly comprises a housing configured to be removably received within a central case of a mortise box, a ball latch having a spherical head portion with blended angled sides formed on a bolt, and a spring force mechanism including a plurality of spring members disposed around a threaded member with an adjustment block for adjusting compression. Additional aspects include a wearable component configured to install in an aperture of the ball latch, including ribs for engagement, a covering component extending over the tip of the ball latch, and a wear indicator configured to provide a visual alert when wear progresses to a predetermined level. Other exemplary aspects include an adjustable or variable spring force in the cassette.

### CROSS-REFERENCE TO RELATED APPLICATION

This application claims priority to, and the benefit of, U.S. Provisional Patent Application No. 63/761,666, filed Feb. 21, 2025, the entire contents of which are hereby incorporated by reference.

### TECHNICAL FIELD

The present disclosure relates to a multipoint lock for moveable closures, particularly door panels that are secured relative to a frame in a closed position.

### BACKGROUND

Homeowners and business owners often prefer multipoint locks for securing their entry door panels. Multipoint locks include spaced apart latches or bolts, which traditionally provide a more secure retention of the door panel compared to using a single cylindrical latch. Multipoint locks may also improve upon the retention of door panels that include a cylindrical latch combined with a conventional deadbolt placed in close proximity to the cylindrical latch. Multipoint locks can also improve the alignment between the door panel and the frame, leading to an improved seal against water and air infiltration.

As shown in FIG. 1, prior art multipoint locks for entry door applications typically use multipoint hardware 10 consisting of a set of handle levers 12, a thumb turn 14, a key cylinder 16, and a pair of escutcheons 18. The multipoint hardware 10 is typically designed specifically for use with a multipoint lock. For example, handle levers 12 frequently are used instead of knobs to increase the torsional mechanical advantage when rotating the handle, because significant operational forces are typically required to drive the plurality of latches or bolts of a multipoint lock. In some instances, the handle levers 12 facilitate separate functions whether the handle lever is rotated upward or downward.

As a result of requiring multipoint hardware 10 that is specific to multipoint locks, availability and design variety of the multipoint hardware can be limited compared to the widely available single point cylindrical lock hardware on the market. FIGS. 2A and 2B show a typical knob 20 for a cylindrical latch according to a first embodiment. The knob 20 includes an asymmetric spindle 22. FIGS. 3A and 3B show a typical knob 30 for a cylindrical latch according to a second embodiment. The knob 30 has a square shaped spindle 32. Each knob 20, 30 may have a spring associated therewith to return the knob to a home position when released by a user. FIG. 4 shows an alternative hardware configuration for a cylindrical latch that includes thumb actuated hardware 40 with a thumb latch 42.

FIG. 5 shows door panel 50 in a closed position. The door panel 50 may be pre-bored with a first through bore 52 configured to allow hardware to interface with a cylindrical latch. The door panel 50 may also include a second pre-bored through bore 54 configured to allow hardware to interface with a cylindrical deadbolt. FIGS. 6A and 6B show detailed views of the door panel 50. The on-center distance M (FIG. 6B) between the first and second through bores 52, 54 is typically standardized as 5½ inches. The setback distance SB (FIG. 6B) between the center of each through bore 52, 54 and the unhinged edge 56 (FIG. 6A) of the door panel 50 is typically standardized as 2⅜″. In one embodiment, the door panel 50 is constructed from wood, but may also be formed in whole or in part by steel, fiberglass, or other suitable materials. The door panel 50 is hinged to a door frame 60. The door frame 60 may include some or all of a header, one or more jambs, an astragal, a mullion, and a sill. Known multipoint locks may not be suitable for use with the door panel 50 because the through bores 52, 54 are not at appropriate locations for multipoint lock hardware. As a result, multipoint locks are traditionally incorporated into custom door panels, further reducing the availability and design variety available to homeowners.

The applicant's own U.S. Pat. No. 10,876,324 is also incorporated by reference herein as providing certain embodiments for improved multi-point locks.

The present specification recognizes advantages of modifications of such designs for differing purposes, as will be further described in the disclosure below.

### SUMMARY

One embodiment of the present disclosure includes a multipoint lock including a cassette housed in a central case, along with at least one auxiliary latch, a latch drive hub; and a deadbolt drive hub. In exemplary aspects, the cassette is removably housed in the central case.

In further exemplary aspects, the cassette includes a ball latch detent outwardly biased by a spring force in the cassette. In further exemplary aspects, the spring force is adjustable.

In further exemplary aspects, the spring force comprises multiple springs disposed in the cassette.

In additional exemplary aspects, the multiple springs have at least two different spring forces. In other exemplary aspects, the spring force is non-linear.

In further exemplary aspects, the ball latch detent includes an aperture configured to receive a replaceable, wearable member protruding from a tip thereof.

Another embodiment of the present disclosure includes a cassette assembly for a multipoint lock comprising a housing configured to be removably received within a central case of a mortise box, a ball latch disposed at one end of the housing having a spherical head portion, and a spring force mechanism disposed within the housing and configured to bias the ball latch outwardly. In exemplary aspects, the ball latch includes blended angled sides formed on a bolt extending from the spherical head portion. In further exemplary aspects, the spring force mechanism comprises a plurality of spring members disposed around a threaded member, and an adjustment block connected to the ball latch via the threaded member, wherein rotation of the threaded member translates the adjustment block to adjust compression of the plurality of spring members. In additional exemplary aspects, a spring retainer is positioned at an end of the housing opposite the ball latch and configured to retain the plurality of spring members. In further exemplary aspects, the ball latch includes a channel extending through a tip thereof configured to receive a tool for adjustment of the spring force mechanism, and a pocket configured to receive a head of the threaded member. In additional exemplary aspects, the cassette assembly includes a replaceable wearable member configured to be received within an aperture of the ball latch, wherein the wearable member includes ribs configured to engage interior walls of the aperture, a covering component configured to extend at least partially over the tip of the ball latch, and a wear indicator configured to provide a visual alert when wear progresses to a predetermined level.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

FIG. 1 shows prior art multipoint hardware for a multipoint lock.

FIGS. 2A and 2B show a first embodiment of a prior art knob traditionally used for operating a cylindrical latch.

FIGS. 3A and 3B show a second embodiment of a prior art knob traditionally used for operating a cylindrical latch.

FIG. 4 shows prior art thumb-actuated hardware used for operating a cylindrical latch.

FIG. 5 shows a prior art pre-bored door panel within a door frame.

FIGS. 6A and 6B show a detailed end view and cross-sectional side view, respectively, of a door panel modified for use with a multipoint lock of the present disclosure.

FIG. 7 is a perspective view of a multipoint lock according to an embodiment of the present disclosure.

FIGS. 8A, 8B, and 8C are side views of an embodiment of a multipoint lock in a latched position, a retracted position, and a deadbolt position respectively.

FIGS. 9A and 9B are detailed views of an auxiliary latch according to the embodiment of FIG. 7 in a recessed position and a deadbolt position respectively.

FIGS. 10A-C are detailed views of a mortise box of the multipoint lock of FIG. 7 in a latched position, a retracted position, and a deadbolt position respectively.

FIGS. 11A-C are detailed views of a top portion of the mortise box of FIGS. 10A-C showing the latched position, the retracted position, and the deadbolt position respectively, with the mortise box cover omitted.

FIGS. 12A-C are detailed views of the top portion of the mortise box of FIGS. 11A-C showing the latched position, the retracted position, and the deadbolt position respectively, with the drive plate also omitted.

FIGS. 13A-C are detailed views of a bottom portion of the mortise box of FIGS. 10A-C showing the latched position, the retracted position, and the deadbolt position respectively, with the cover omitted.

FIGS. 14A-C are detailed views of the bottom portion of the mortise box of FIGS. 13A-C showing the latched position, the retracted position, and the deadbolt position respectively, with the drive plate also omitted.

FIGS. 15A and 15B are front and rear views of adaptors suitable for reconfiguring the multipoint lock of FIG. 7.

FIG. 16 is a perspective view of an exemplary installed cassette with ball latch detent.

FIG. 17 is a perspective view of an exemplary center member with the installed cassette provided therein.

FIG. 18 is a perspective view of exemplary cassette internal members.

FIGS. 19A and 19B show a perspective view and a side view respectively of a bolt and latch subassembly for the cassette.

FIG. 20 is a perspective view of an exemplary bolt head configured as a ball latch.

FIG. 21A-21F illustrate an exemplary ball latch configured with a replaceable, wearable member.

FIG. 22A-22F illustrate exemplary embodiments of wearable members for the ball latch, also including wear indicators.

FIG. 23 is additional perspective view of ball latch and/or cassette components.

### DETAILED DESCRIPTION

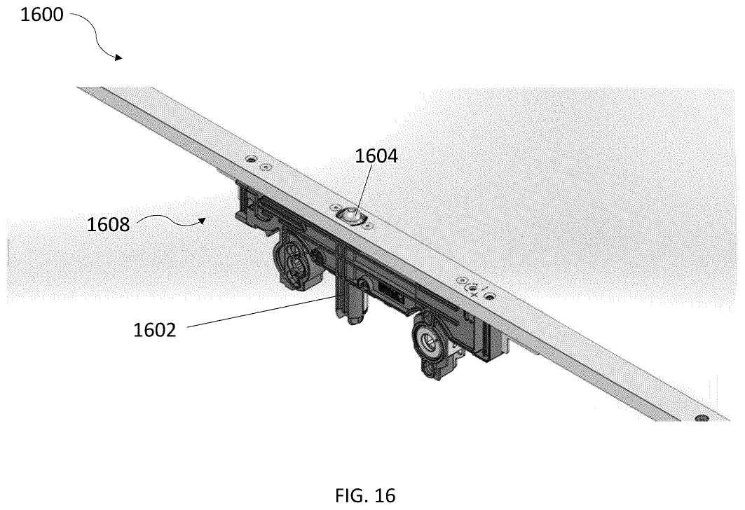

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa. Further, and with specific reference to FIGS. 5-15B, we note that those Figures describe an exemplary multipoint lock with a latch as per applicant's own U.S. Pat. No. 10,876,324, which is incorporated by reference herein, rather than utilizing the ball/spring latch described with reference to FIGS. 16-21E. Though it is reiterated in sections below, in general, exemplary embodiments utilizing a ball/spring latch or a cassette as per FIGS. 16-21E instead of a traditional latch may be configured differently and may operate differently, e.g., by not including a main latch and instead including a ball/spring latch or cassette, by modifying or locking out features, such as main latch handle rotation or other aspects shown in FIGS. 5-15B.

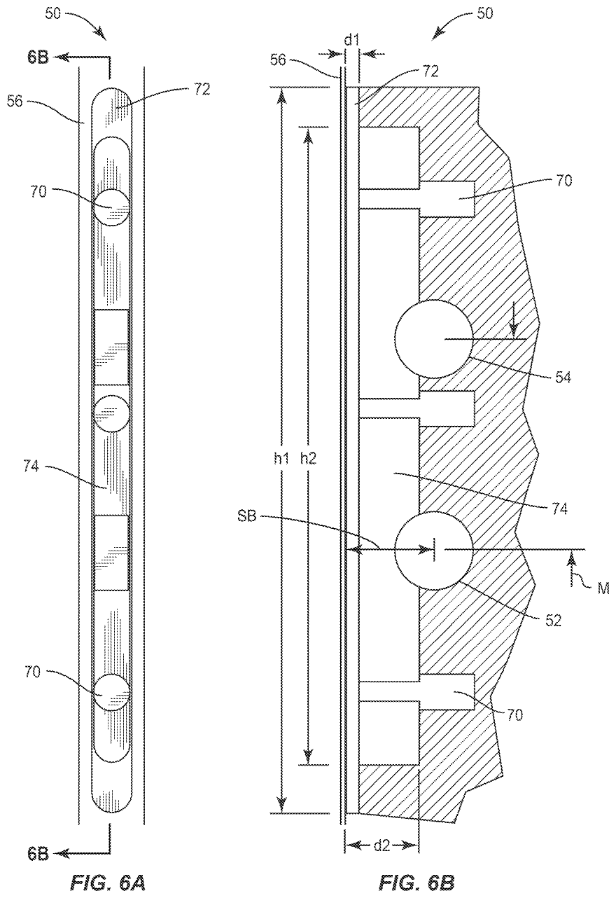

In one embodiment, and as illustrated in FIGS. 5, 6A, and 6B, the present disclosure describes a multipoint lock suitable for use with a door panel 50 with pre-bored through bores 52, 54 configured for a cylindrical latch and cylindrical deadbolt. Designing a multipoint lock for such use is advantageous because it provides the user access to a greater variety of door panel options. With reference to FIGS. 6A and 6B, a door panel 50 intended for use with a cylindrical latch and cylindrical deadbolt as shown in FIG. 5 may be prepared for a multipoint lock according to embodiments of the present disclosure with one or more modifications. To prepare the unhinged edge 56, which is the edge adjacent to the through bores 52, 54, for accepting a multipoint lock, a step may include creating one or more recesses 70 perpendicular to and centered on a minor axis of the unhinged edge 56. The recesses 70 may be sized, shaped, and spaced to correspond with auxiliary latches, or the housings thereof, of a multipoint lock. A first slot 72 may be formed into the unhinged edge 56, centered on the minor axis of the edge, and having a first depth d1 and a first height h1. The first slot 72 may be configured for accepting a lock channel and an optional face plate of the multipoint lock. At least a second slot 74 may be formed into the unhinged edge 56, centered on the minor axis of the edge, and having a second depth d1 and a second height h2. The second slot 74 may be configured to receive a mortise box of the multipoint lock. Therefore, the second depth may be greater than the first depth measured perpendicular to the unhinged edge 56. The second height may be less than the first height measured along the unhinged edge 56.

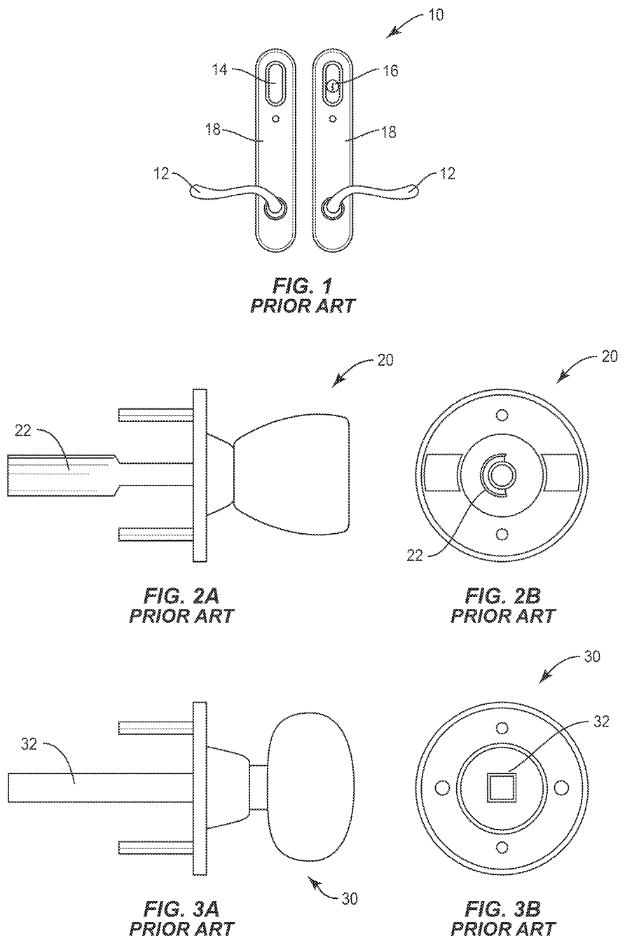

In one embodiment, the present disclosure also seeks to provide a multipoint lock whose construction provides smooth operation of multiple latches with minimal operational forces necessary to operate the multiple latches. Reducing or minimizing operational force requirements facilitates comfortable actuation with knobs 20, 30 (FIGS. 2 and 3) instead of handle levers 12 (FIG. 1), though levers may still be used if desired by the operator.

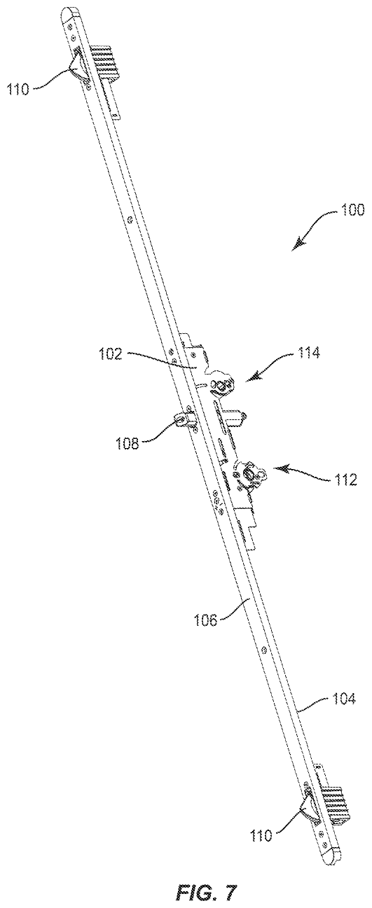

FIG. 7 shows a multipoint lock 100 according to an embodiment of the present disclosure. As used herein, the term “multipoint lock” means a device for securing a door panel in a closed position relative to a door frame with at least two points of engagement between the door panel and the door frame, wherein the points of engagement are spaced apart by at least about twelve inches. The multipoint lock 100 includes a mortise box 102, a lock channel 104, a face plate 106, a main latch 108, and at least one auxiliary latch 110. As used herein, the term “latch” is used broadly to include any structure configured to extend and retract relative to an edge of a door panel, including components traditionally referred to by one of ordinary skill in the art as latches, latch bolts, and bolts. The mortise box 102 may at least partially house a latch drive hub 112 and a deadbolt drive hub 114. According to an embodiment, the lock channel 104 may be configured and dimensioned to reside within the first slot 72 (FIGS. 6A and 6B). The mortise box 102 may be configured and dimensioned to reside within the second slot 74. Also, the latch drive hub 112 and the deadbolt drive hub 114 are spaced from each other, and offset from the face plate 106, such that the latch drive hub and the deadbolt drive hub may be substantially centered within the through bores 52 and 54 (FIG. 6B) respectively. In one embodiment, the latch drive hub 112 and the deadbolt drive hub 114 are spaced apart by a vertical distance to correspond with the on-center distance M (FIG. 6B) between the through bores 52, 54 of the door panel 50 (FIGS. 5, 6B). Similarly, the distance between the face plate 106 and the center of each of the latch drive hub 112 and deadbolt drive hub 114 may be designed to correspond with the setback distance SB (FIG. 6B) of the through bores 52, 54 of the door panel 50. In this embodiment, the multipoint lock 100 can be installed into a pre-bored door panel 50 initially intended for receiving cylindrical lock components after one or more modifications to the door panel are made, as discussed above.

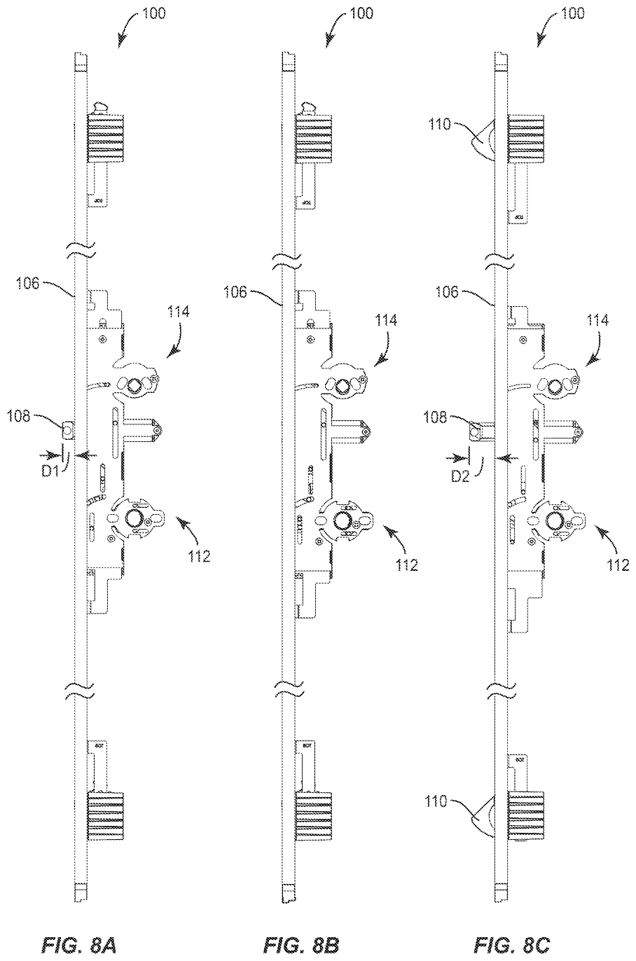

FIGS. 8A-8C show the three positions of the multipoint lock 100 according to the present embodiment. FIG. 8A shows a first, latched position in which the main latch 108 extends from the face plate 106 by a first distance D1 to engage the door frame 60 (FIG. 5) when the door panel 50 is closed. In one embodiment, the latched position is a home position of the main latch 108. In the illustrated embodiment, each of the auxiliary latches 110 is retracted in the latched position. In other embodiments, the pair of auxiliary latches 110 may extend from the face plate 106 toward the door frame 60, such as, by approximately the first distance of extension of the main latch 108 in the latched position of the multipoint lock 100.

FIG. 8B shows the retracted position of the multipoint lock 100. The retracted position allows the door panel 50 (FIG. 6B) to be opened relative to the door frame 60 (FIG. 5). In the retracted position, the main latch (not shown in FIG. 8B) is substantially recessed relative to the unhinged edge of the door panel. In the retracted position, each of the auxiliary latches will also be withdrawn to be located substantially flush with, and rearward of the face plate 106. In the illustrated exemplary embodiment utilizing a traditional latch, transitioning from the latched position (FIG. 8A) to the retracted position (FIG. 8B) may occur by imposing a rotational force to rotate the latch drive hub 112 as discussed in more detail below. Preferably, from the latched position of the latch drive hub 112, the latch drive hub 112 may be rotated in both a clockwise and counterclockwise direction relative to the same side of the door panel to retract the main latch 108. However, in other exemplary embodiments described below relating to use of a ball or spring latch or cassette in lieu of a traditional latch, the latch drive hub may be locked out by internal parts. For example, handles not installed without adapters can be configured, e.g., to turn but not have an effect on the internals of the lock; while handles installed with adapters can be locked out by internal parts, only used as a push pull device to operate the door.

FIG. 8C shows a deadbolt position of the multipoint lock 100 used to secure the door panel 50 (FIG. 5) in a closed position relative to the door frame 60. In the deadbolt position, each auxiliary latch 110 extends from the face plate 106 toward, and into engagement with, the door frame 60 (FIG. 5). If the auxiliary latches 110 extend from the face plate 106 in the latched position, not present in the illustrated embodiment, the auxiliary latches may extend by a second distance greater than the first distance from the unhinged edge of the door panel in the deadbolt position. In the deadbolt position, the main latch 108 may continue to extend relative to the face plate 106 by the first distance, as in the latched position of the main latch. In a preferred embodiment, as illustrated, in the deadbolt position, the main latch 108 extends outward from the face plate 106 by a second distance D2 greater than the first distance D1 (FIG. 8A). In one embodiment, the deadbolt position of the multipoint lock 100 is achieved by applying a rotational force upon the deadbolt drive hub 114 as discussed further below. In one embodiment, the multipoint lock 100 is transitioned from the latched position (FIG. 8A) to the deadbolt position (FIG. 8C) by rotating the deadbolt drive hub 114 toward the face plate 106, and is returned to the latched position by rotating the deadbolt drive hub in the opposite direction, away from the unhinged edge 56 of the door panel 50 (FIG. 6B). As noted above, other exemplary embodiments utilizing a ball/spring latch or a cassette instead of a traditional latch may be configured differently and may operate differently, e.g., not extending in the same manner as described above.

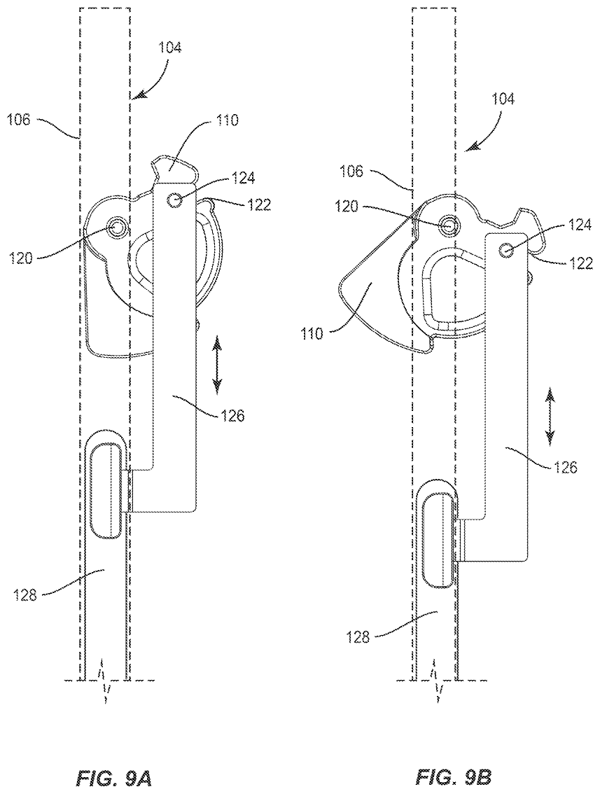

FIGS. 9A and 9B show a detailed view of an auxiliary latch 110 according to one embodiment. An optional housing for the auxiliary latch 110 has been omitted for clarity of illustration. The auxiliary latch 110 in the illustrated embodiment is configured to pivot between a recessed position (FIG. 9A) and a deadbolt position (FIG. 9B) relative to the face plate 106. For example, a pivot pin 120 may be supported by the lock channel 104 and pass through an aperture within the auxiliary latch 110. A slot 122 formed in the auxiliary latch 110 may be configured to receive a roller pin 124. The roller pin 124 may be mounted to an extension link 126 that is fixed relative to a connector rod 128, which may be at least partially received within the lock channel 104. The connector rod 128, and therefore the extension link 126, are configured to be translated vertically during one or more operations of the multipoint lock 100. Relative to FIG. 9A, which shows the auxiliary latch 110 in the recessed position, lowering the extension link 126 will pivot the auxiliary latch toward the extended position thereof as shown in FIG. 9B. In some embodiments, not shown, the auxiliary latch 110 may be configured to hook onto a catch provided as part of the door frame 60 (FIG. 5). In other embodiments, the auxiliary latch 110 may be configured to travel linearly between the recessed position and one or more extended positions. In other embodiments, the auxiliary latch 110 may additionally or alternatively comprise shoot bolts configured to extend vertically relative to a door panel. As noted above, other exemplary embodiments utilizing a ball/spring latch or a cassette instead of a traditional latch may be configured differently and may operate differently, e.g., not including traditional latch components as described above.

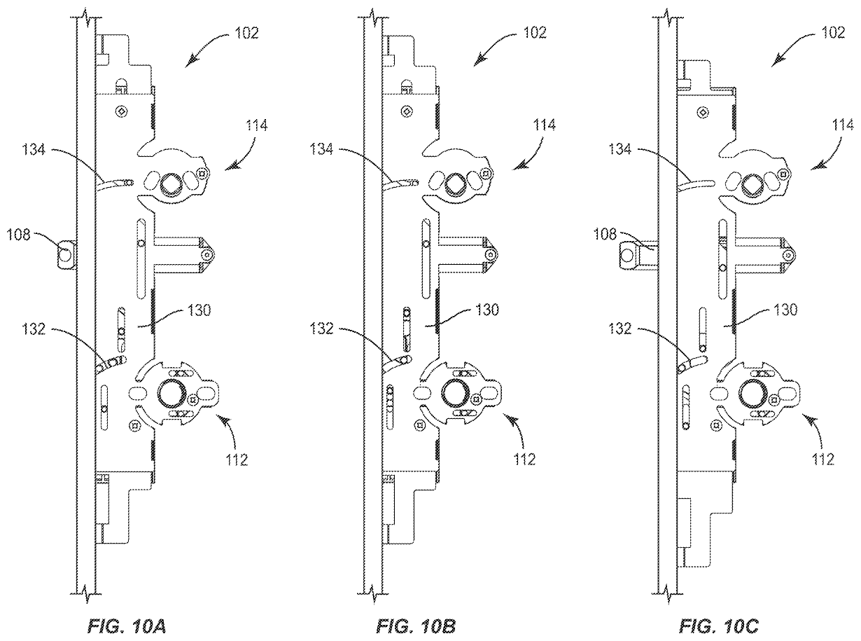

FIGS. 10A-C show a detailed view of the mortise box 102 in the latched, retracted, and deadbolt positions respectively. As discussed above, the mortise box 102 may be constructed to locate the latch drive hub 112 and the deadbolt drive hub 114 for substantially centered placement within the pre-bored through bores 52, 54 of a door panel 50 (FIG. 5). The mortise box 102 may include a cover 130. The cover 130 may be formed with a latch guide slot 132 configured to guide travel of components when the latch drive hub 112 is rotated. The cover 130 may also include a deadbolt guide slot 134 configured to guide travel of components when the deadbolt drive hub 114 is rotated. Each of the latch guide slot 132 and the deadbolt guide slot 134 may be arcuate in shape. As noted above, other exemplary embodiments utilizing a ball/spring latch or a cassette instead of a traditional latch may be configured differently and may operate differently, e.g., not including traditional latch components as described above.

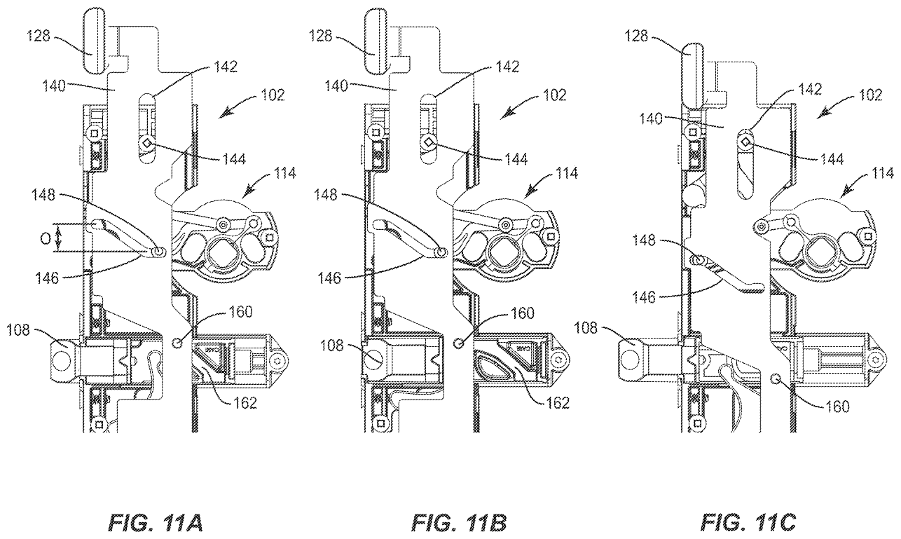

FIGS. 11A-C show detailed views of the upper portion of the mortise box 102, including the deadbolt drive hub 114, with the cover 130 of the mortise box and the lock channel 104 omitted. FIG. 11A shows the latched position, FIG. 11B shows the retracted position, and FIG. 11C shows the deadbolt position. A drive plate 140 may be located at least partially within the mortise box 102. The drive plate 140 is translationally fixed relative to the connector rod 128, which extends toward the auxiliary latch 110 (FIG. 7). The drive plate 140 and the connector rod 128 may be a single integral component or multiple pieces attached together. The drive plate 140 may have a drive plate guide slot 142, which receives a drive plate guide boss 144. The drive plate guide slot 142 may be positioned vertically to guide the vertical movement of the drive plate 140. The drive plate guide boss 144 may be provided as part of the mortise box 102. In the illustrated embodiment, the drive plate 140 is in a raised position relative to the mortise box 102 in the latched and retracted positions (FIGS. 11A and 11B), and in a lowered position relative to the mortise box in the deadbolt position (FIG. 11C). In the illustrated embodiment, the drive plate 140 is translated as a result of sliding interaction between an actuation slot 146 formed in the drive plate 140, and an actuation pin 148. The actuation slot 146 may be described as being shaped like an escalator, with a sloped midsection and offset horizontal ends. The offset distance O (FIG. 11A) dictates the magnitude of vertical travel of the drive plate 140. The angle of the sloped midsection relative to horizontal may impact the force required to return the multipoint lock 100 from the deadbolt position to the latched position. Because the deadbolt position of the illustrated embodiment locates the drive plate 140 in a lowered position, gravity is able to assist, i.e. reduce the required input force, to transition the multipoint lock 100 from the latched position to the deadbolt position. As noted above, other exemplary embodiments utilizing a ball/spring latch or a cassette instead of a traditional latch may be configured differently and may operate differently, e.g., not including traditional latch components as described above.

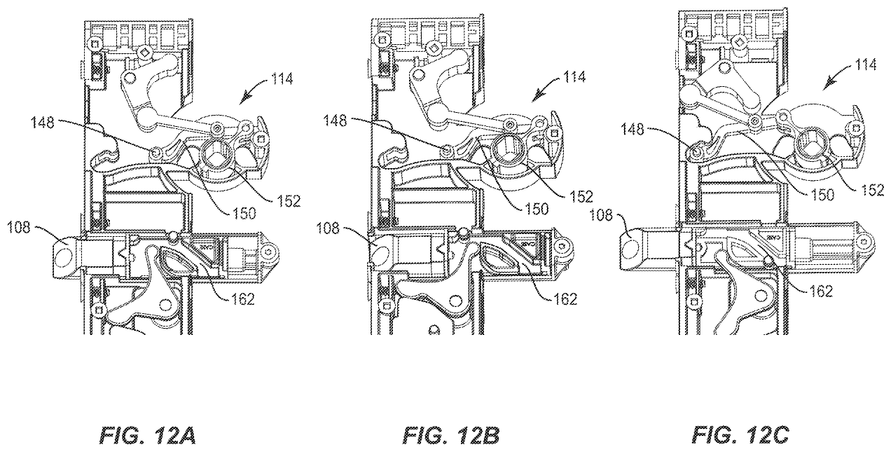

To translate the drive plate 140, the actuation pin 148 is shifted along the actuation slot 146. Compare, for example, FIGS. 11B and 11C. As shown in FIGS. 12A-C, where the drive plate has been omitted, the actuation pin 148 may be provided at an outer end of a link arm 150. An inner end of the link arm 150 may be pivotably joined with a deadbolt lever 152 of the deadbolt drive hub 114. As will be understood by one of ordinary skill in the art, to transition from the latched position (FIG. 12A) to the deadbolt position (FIG. 12C), and vice versa, an operator can cause rotation of the deadbolt lever 152 with external hardware such as a key cylinder or thumb-turn. As the deadbolt lever 152 is rotated, the actuation pin 148 follows the constrained path defined by the deadbolt guide slot 134 (FIGS. 10A-C) in the cover 130. As the actuation pin 148 travels along the deadbolt guide slot 134, the shape of the actuation slot 146 (FIGS. 11A-C) and its interaction with the actuation pin 148 raises or lowers the drive plate 140.

Returning to FIGS. 11A-C, vertically translating the drive plate 140 from the raised position to the lowered position also causes the main latch 108 to extend from the first extended position of the latched position to the second extended position of the deadbolt position in the illustrated embodiment. The drive plate 140 carries a deadbolt pin 160, which travels within and bears against a camway 162 attached to or formed with the main latch 108. As the deadbolt pin 160 travels downward with the drive plate 140, the shape of the camway 162 forces the main latch 108 to the deadbolt position. As noted above, other exemplary embodiments utilizing a ball/spring latch or a cassette instead of a traditional latch may be configured differently and may operate differently, e.g., not including traditional latch components as described above.

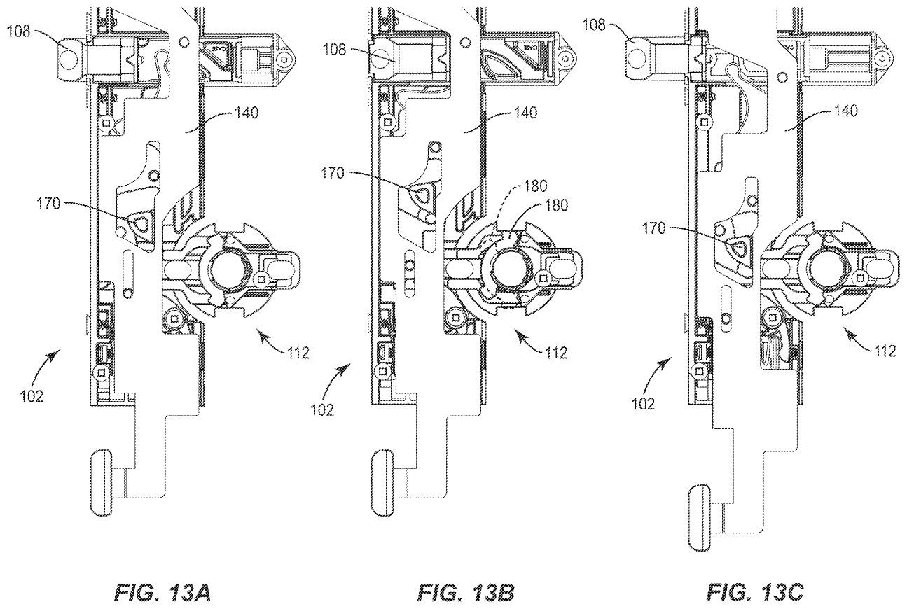

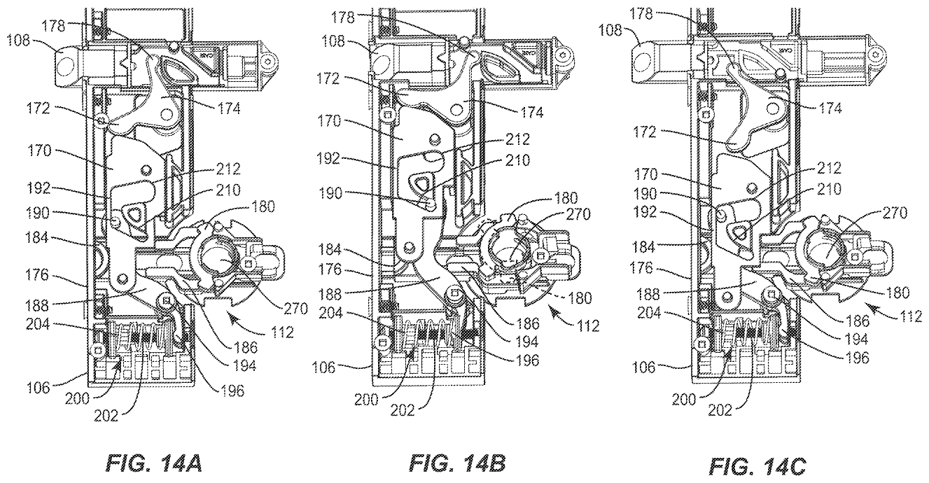

FIGS. 13A-C show a detailed view of the lower portion of the mortise box 102, including the latch drive hub 112, with the cover 130 (FIG. 10A) of the mortise box omitted. Again, FIG. 13A shows the latched position, FIG. 13B shows the retracted position, and FIG. 13C shows the deadbolt position. As possibly best seen in FIGS. 14A-C, a slide 170 is shifted upward in the latched position and downward in the deadbolt position. The slide 170 translates with motion of the drive plate 140 (FIGS. 13A-C). An abutment surface at the top of the slide 170 may contact a first end 172 of a bell crank 174. The bell crank 174 may be pivotably mounted in the case 176 of the mortise box 102. Therefore, translation of the slide 170 can cause rotation of the bell crank 174. A second end 178 of the bell crank 174 may contact an abutment surface formed with the main latch 108. Therefore, the bell crank 174 may assist with sliding the main latch 108 from a respective latched position to a retracted position as the bell crank rotates with the upward motion of the slide 170. As noted above, other exemplary embodiments utilizing a ball/spring latch or a cassette instead of a traditional latch may be configured differently and may operate differently, e.g., not including traditional latch components as described above.

FIGS. 13B and 14B show a detailed view of the lower portion of the mortise box 102, each with the cover 130 removed. FIG. 14B further omits the drive plate 140. The main latch 108 is shown in a retracted position. According to the present embodiment, the main latch 108 translates from the latched position to the retracted position when a rotational input force is provided by an operator at the latch drive hub 112, particularly a handle hub 180. According to a preferred embodiment, a rotational input in both a clockwise and a counterclockwise direction relative to the same side of a door panel, from an initial position of the handle hub 180, may cause the main latch 108 to retract from the latched position. FIGS. 13B and 14B show the handle hub 180 in dashed lines to represent the position of the handle hub if the latch drive hub 112 were rotated counterclockwise in the illustrated views. In one embodiment, the other components effected by rotation of the handle hub 180 arrive at the same position independent of the direction of rotation of the handle hub. In some embodiments, rotating the handle hub 180 will not retract the main latch 108 if the multipoint lock 100 is in the deadbolt position (see FIG. 14C). In some embodiments, the multipoint lock 100 may be provided with a “panic” feature. If provided, a “panic” feature retracts the main latch 108 and the auxiliary latch 110 (FIG. 7) with rotation of the handle hub 180 using an interior handle or knob, even if the multipoint lock 100 is in the deadbolt position. If the “panic” feature is provided, the deadbolt position of the multipoint lock 100 either prevents rotation of an exterior handle, or rotation of an exterior handle when the multipoint lock is in the deadbolt position will not retract any of the latches 108, 110. As noted above, other exemplary embodiments utilizing a ball/spring latch or a cassette instead of a traditional latch may be configured differently and may operate differently, e.g., not including traditional latch components as described above.

Again, the multipoint lock 100 may achieve the retracted position of FIG. 14B from the latched position of FIG. 14A by rotating the handle hub 180 from an initial position, i.e. the latched position, to a rotated position using hardware as shown in FIG. 1, for example. The periphery of the handle hub 180 is provided with a cam shape such that rotation of the handle hub 180 can have the effect of pulling a distal end 184 of a transfer bar 186 away from the face plate 106. The transfer bar 186 acts upon a latch drive link 188. A latch drive pin 190 at one end of the latch drive link 188 travels within an aperture 192 of the slide 170. Interaction between the latch drive pin 190 and the aperture 192 causes the slide 170 to rise farther from the latched position thereof. Further lifting of the slide 170 further rotates the bell crank 174, whose second end 178 presses the main latch 108 toward the retracted position (FIG. 14B). As noted above, other exemplary embodiments utilizing a ball/spring latch or a cassette instead of a traditional latch may be configured differently and may operate differently, e.g., not including traditional latch components as described above.

Staying with FIGS. 14A-C, the latch drive link 188 may be pivotably mounted to the case 176 about a pivot point 194 located along the length of the latch drive link. An opposite end 196 of the latch drive link 188 may provide an abutment surface for a latch return assembly 200. The latch return assembly 200 may include an adjustment screw 202 that is accessible through the face plate 106. Rotating the adjustment screw 202 is configured to adjust the tension on a spring 204, thereby adjusting the amount of biasing force applied to the opposite end 196 of the latch drive link 188 for returning the latch drive link and the main latch 108 from the retracted position to the latched position. The spring 204 may also contribute to rotation of the handle hub 180, and the hardware attached thereto, back to a home position after being released by the operator.

As shown in FIGS. 14A-C, the aperture 192 within the slide 170 can be configured as a C-shape. The latch drive pin 190 travels along the substantially vertical portion of the C-shape as the slide 170 adjusts vertically while the multipoint lock 100 transitions between the deadbolt position (FIG. 14C) and the latched position (FIG. 14A). The latch drive pin 190 is aligned with, travels along, and provides an abutment force to a lower branch 210 of the C-shaped aperture 192 to transition the multipoint lock 100 (FIG. 7) from the latched position to the retracted position. The latch drive pin 190 is aligned with and enters an upper branch 212 of the C-shaped aperture 192 when the deadbolt drive hub 114 is in the deadbolt position and the handle hub 180 is rotated. The upper branch 212 is sized and shaped such that the latch drive pin 190 freely travels within the upper branch and does not provide significant forces to the edges thereof. Therefore, rotating the handle hub 180 while the multipoint lock 100 is in the deadbolt position will cause movement of the latch drive pin 190, but the motion of the latch drive pin will not be transmitted to motion of the slide 170. As noted above, other exemplary embodiments utilizing a ball/spring latch or a cassette instead of a traditional latch may be configured differently and may operate differently, e.g., not including traditional latch components as described above.

In one embodiment, the multipoint lock 100 (FIG. 7) according to the embodiments discussed above facilitates being operated by hardware typically reserved for operating a cylindrical lock, thereby increasing the choices and availability of hardware available for use with multipoint locks. In one example, the multipoint lock 100 mirrors the functionality traditionally associated with knob-operated cylindrical latches in that the main latch 108 will retract from the latched position with rotation of the handle hub 180 in either direction from an initial position thereof. As noted above, other exemplary embodiments utilizing a ball/spring latch or a cassette instead of a traditional latch may be configured differently and may operate differently, e.g., not including traditional latch components as described above.

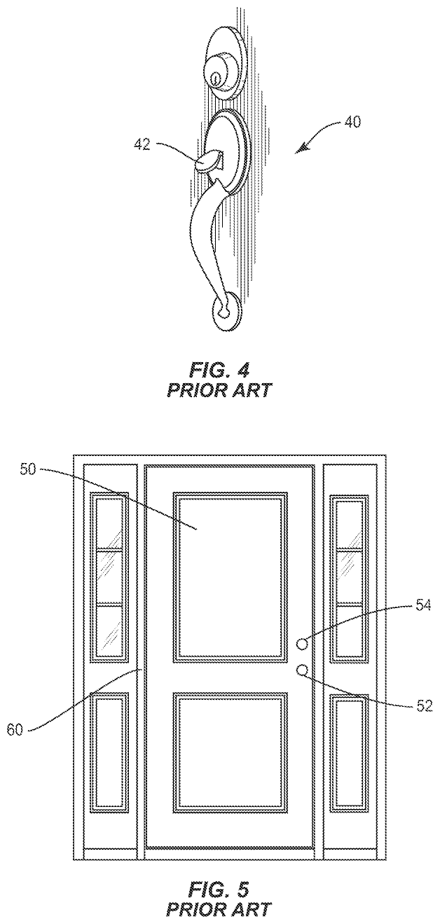

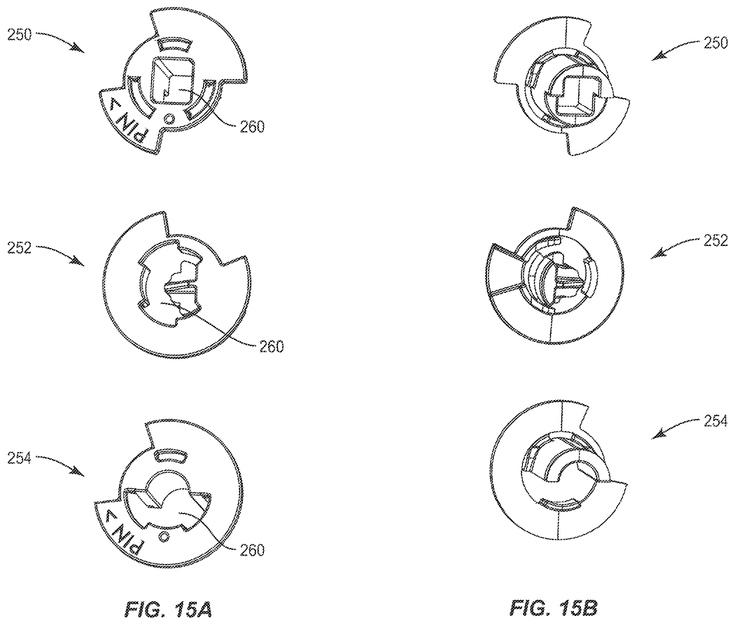

In another example of a feature that facilitates use with cylindrical lock hardware, the handle hub 180 (FIG. 13A) is designed to be reconfigurable such that the handle hub may be operated, i.e. rotated, with any of a handle lever 12 (FIG. 1), a knob 20, 30 (FIGS. 2 and 3) or a thumb latch 42 (FIG. 4). As such, the handle hub 180 is suitable for actuation by hardware traditionally designed to engage with cylindrical latches. In one embodiment, the handle hub 180 is configurable to universally accept entry door hardware regardless of the configuration or original manufacturer through the selective use of one or more hub adaptors 250, 252, 254 as shown in FIGS. 15A and 15B. One of ordinary skill in the art can appreciate that the handle hub 180 without an adaptor 250, 252, 254 in-use can constitute a first configuration suitable for use with some entry door hardware. The adaptors 250, 252, 254 each have a bore 260 of a different geometry to reconfigure the shape of a passage 270 (FIG. 14A) through the handle hub 180. The passage 270 is used to receive the spindle from a respective hardware set given that hardware of the various types described above have spindles of various sizes and shapes. In one embodiment, the adaptors 250, 252, 254 may attach to the handle hub 180, or another adaptor, with a friction fit. In other embodiments (not shown), the adaptors 250, 252, 254 may be formed with integral spring legs to snap or clip into engagement with the handle hub 180. Alternatively, the handle hub 180 may be configured with resilient portions to selectively retain the adaptors 250, 252, 254. As noted above, other exemplary embodiments utilizing a ball/spring latch or a cassette instead of a traditional latch may be configured differently and may operate differently, e.g., not including traditional latch components as described above.

The adaptors 250, 252, 254 may be created and provided on a molding sprue. If provided on a molding sprue, one of ordinary skill in the art will appreciate that the adaptors 250, 252, 254 would be detached from the molding sprue prior to use. A plurality of deadbolt adaptors (not shown) may also be provided to interface with the deadbolt drive hub 114 (FIG. 7) in much the same way as the adaptors 250, 252, 254 selectively interface with the handle hub 180. Thus, the deadbolt drive hub 114 can also be reconfigurable to mate with hardware, such as a thumb turn 14 (FIG. 1), whose spindle may vary depending upon the manufacturer thereof.

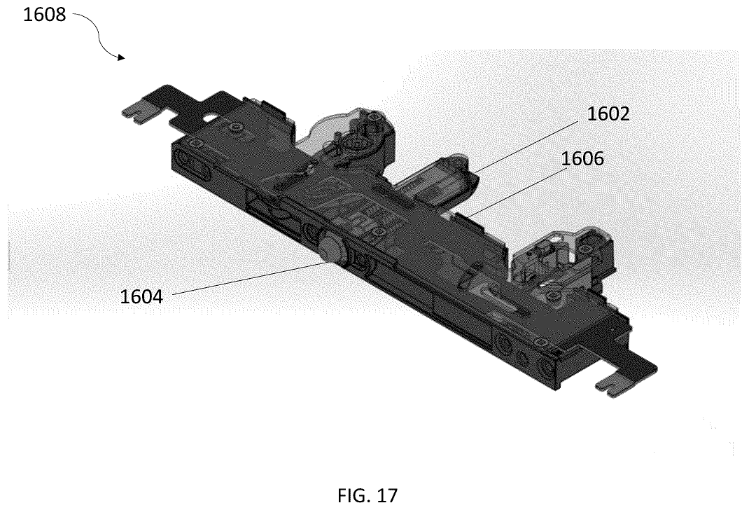

FIG. 16 illustrates another exemplary embodiment of a multi-point lock 1600 utilizing a cassette 1602 to replace the main latch 108 with an alternate component within its mortise box 1608, which in this embodiment includes a ball latch 1604. The cassette 1602 is positioned within the mortise box 1608, with the ball latch 1604 extending outwardly from the cassette 1602 to engage with a corresponding strike on a door frame when the door panel is in a closed position. FIG. 17 shows the mortise box 1608 of FIG. 16 to illustrate an exemplary positioning of the cassette 1602 within the mortise box 1608. In exemplary embodiments, the cassette 1602 is removably secured within a central case 1606 of the mortise box 1608, for example, secured via other parts of the assembly or by one or more fasteners connecting the cassette and the central case 1606. The central case 1606 provides a housing structure that receives and retains the cassette 1602, enabling replacement or servicing of the ball latch mechanism without requiring disassembly of the entire mortise box 1608.

In exemplary embodiments, rotation of a latch or handle is prevented by the configuration of the central case to keep the latch or handle in one place for use as a pull or push handle to overcome the force of the ball latch to open or close the door. In such configuration, the deadbolt latch(es) may be operated by an electronic actuator to automatically lock or unlock the deadbolt(s) so that the user can simply push or pull the door open and shut.

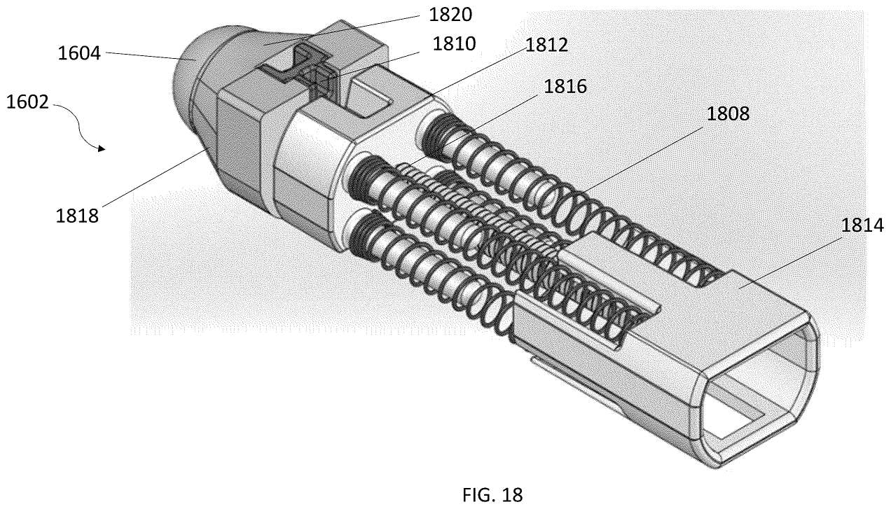

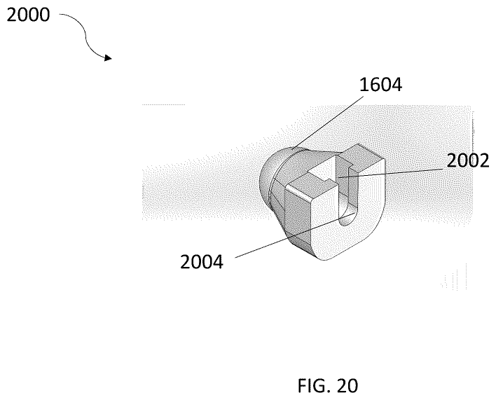

FIG. 18 illustrates exemplary internal components found within the cassette 1602 and their spatial arrangement within the cassette assembly, including a ball latch 1604 positioned at one end, a threaded member 1816, an adjustment block 1812, a spring retainer 1814, and a press fit retainer 1810. The ball latch 1604 features a spherical head portion and blended angled sides 1818 formed on a bolt 1820. The head [not shown] of the threaded member 1816 is situated within a pocket 2002 (see FIG. 20) of the ball latch element 2000. A press fit retainer 1810 is installed through the pocket 2002 of the ball latch element to retain the head of the threaded member 1816, thereby securing the mechanical connection between the threaded member 1816 and the ball latch element 2000.

The adjustment block 1812 comprises four posts configured to support four spring members 1808 and includes a center aperture through which the threaded member 1816 passes. The adjustment block 1812 is connected to the ball latch element 2000 via the threaded member 1816 through the center aperture enabling adjustment of the spring force mechanism by rotating the threaded member 1816. The four spring members 1808 are positioned around the threaded member 1816 and are retained to the adjustment block 1812 via the spring retainer 1814, which is positioned at the opposite end from the ball latch 1604 and configured to receive the spring members 1808 and adjustment block 1812 assembly.

In exemplary embodiments, the ball latch is configured with a predetermined spring configuration to provide a desired holding force, e.g., to hold the panel closed during a 20 mile per hour (mph) wind (or can be customized for any type of maximum wind condition to hold the door in place). By way of example, on an eight by four-foot door weighing 300 pounds, this equates to thirty-two pounds of force across the panel. Four springs having a spring rate of 10.9 pounds per inch can provide that force, with each ¼ inch adjustment of the springs increasing the force by 10.9 pounds. As noted, this is merely an example, since the spring force may be applied by different types of springs (e.g., leaf springs), differing numbers of springs, differing spring force values, etc., as desired. The springs may be adjusted simultaneously by rotating the threaded member 1816, which translates the adjustment block 1812 relative to the spring retainer 1814 to compress or decompress the spring members 1808. Moreover, the cassette 1602 allows for the ease of replacing or substituting of the springs for different purposes by removing the cassette 1602 from the central case 1606.

With reference to components shown generally at 1602 in FIG. 18, the spherical shape of the ball latch 1604 and the blended angled sides 1818 of the bolt 1820 cooperate to allow the bolt to detent along a roller strike until enough pressure or force is applied to allow the latch to be retracted into the central case. The spring members 1808 bias the ball latch 1604 outwardly, and when the door panel is pushed or pulled, the spherical head portion of the ball latch 1604 rides against the strike, compressing the spring members 1808 until the ball latch 1604 clears the strike and the spring members 1808 return the ball latch 1604 to its extended position. The exemplary embodiment also has an adjustable spring force mechanism allowing lowering or raising of the resistance of the spring force to open the door.

Exemplary advantages of the embodiments of FIGS. 16-19 include the ability to keep the door engaged with a weatherstrip even if the door is unlocked, maintaining a draft free opening. Additionally, the exemplary adjustability of the strike/ball latch detent to increase or decrease the compression of the weather strip on doors that might be out of plumb or not square to the door, allowing on-site customization for correctly installing the door.

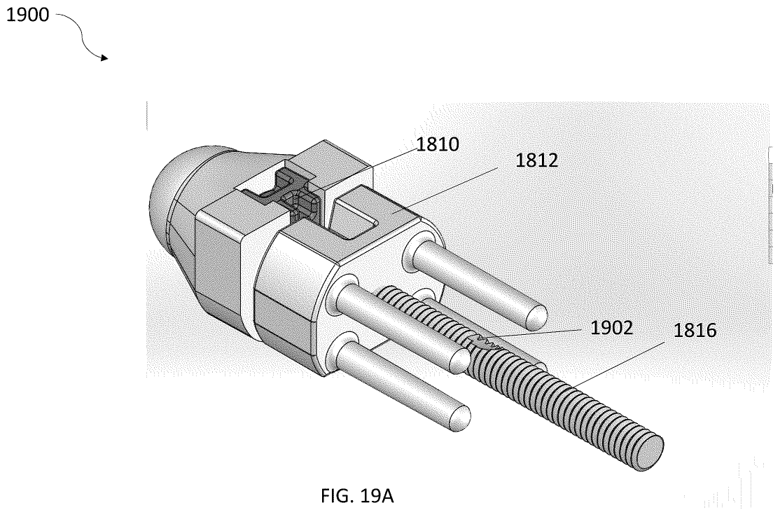

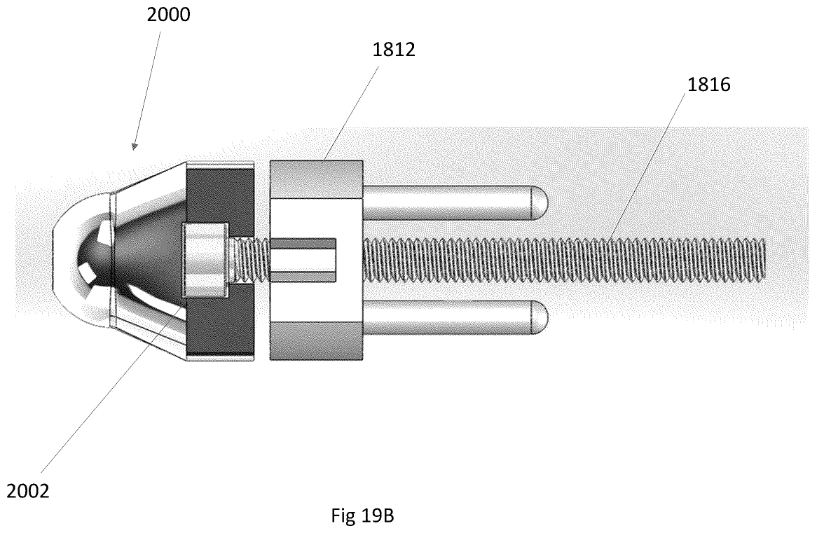

FIG. 19A illustrates an exemplary latch and guide subassembly generally at 1900, showing the mechanical relationship between the press fit retainer 1810, the adjustment block 1812, and the threaded member 1816. The threaded member 1816 includes a divot 1902 positioned along its length which serves to prevent over actuation of the threaded member 1816, and thereby limits the amount of force that can be applied during adjustment. The press fit retainer 1810 is positioned adjacent to the threaded member 1816 and retains the head of the threaded member 1816 in place within the ball latch element, ensuring that the threaded member 1816 remains secured while permitting rotational adjustment. FIG. 19A also illustrates positioning of the adjustment block 1812, which connects to the ball latch element via the threaded member 1816 through its center aperture FIG. 19B illustrates a side view of the bolt and latch subassembly, showing the ball latch element 2000 with its spherical head portion, the pocket 2002 configured to receive the head of the threaded member 1816, and the threaded member 1816 extending toward the adjustment block 1812. Two posts are visible extending from the assembly, positioned on either side of the threaded member 1816, which assist in guiding the linear movement of the ball latch element 2000 during operation and prevent rotational movement of the ball latch element 2000 when the threaded member 1816 is rotated for adjustment.

FIG. 20 illustrates the ball latch element 2000 configured as a ball latch 1604, with a pocket 2002 situated within the body of the ball latch element 2000 for receiving the head of the threaded member 1816. A channel 2004 extends through the tip of the ball latch 1604 and connects to the pocket 2002, providing a pathway that allows a tool (e.g., an allen or torx wrench) to be inserted therethrough for engagement with the head of the threaded member 1816 for adjustment of the spring force. The ball latch 1604 has a rounded, dome-like shape that facilitates smooth engagement and disengagement with a corresponding strike plate.

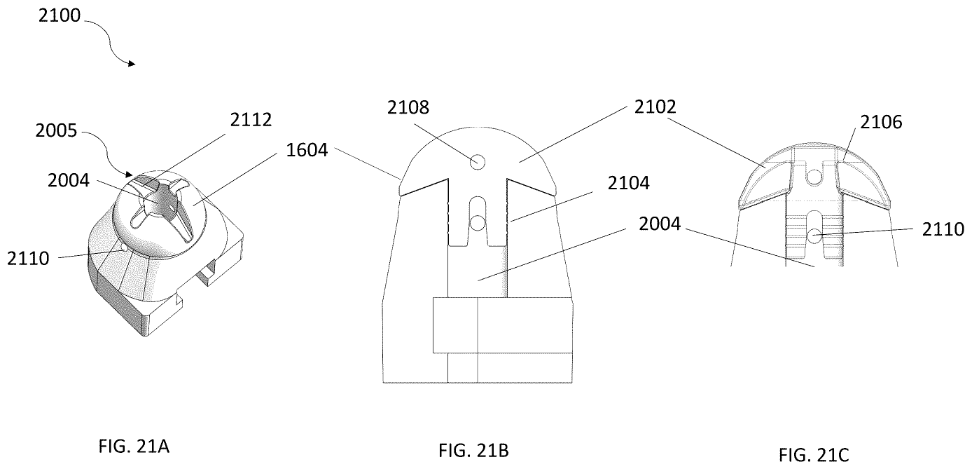

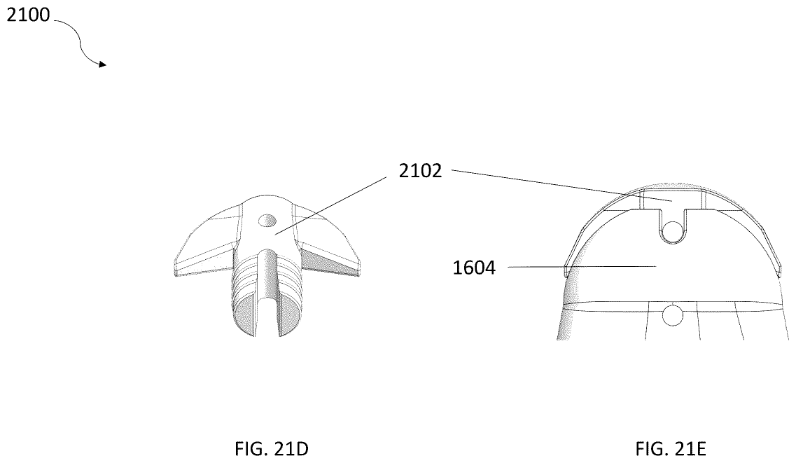

Referring now to FIGS. 21A-21C, the ball latch assembly 2100 is illustrated in perspective, side, and front views, respectively, showing the ball latch 1604 configured to accept a replaceable, wearable member 2102 within channel 2004 over the tip 2005 thereof. The wearable member 2102 is provided to prevent scratching of the strike (not shown) or ball latch 1604 during use and to cover the channel 2004 that provides access to the adjustment screw (not shown). The illustrated exemplary wearable member 2102 is provided with ribs 2104 configured to engage the interior walls of the channel 2004 to hold the wearable member 2102 securely in place, and a covering component 2106 configured to extend at least partially over the tip 2005 of the ball latch 1604 to protect the spherical head portion during operation. In the illustrated exemplary embodiment, a pin hole 2108 is provided through the wearable member 2102 to allow a tool, such as a paper clip, to be inserted and used to remove the wearable member 2102 from the channel 2004 by leverage or by lifting it out. A second pin hole 2110 is illustrated in the side of the ball latch 1604 to allow a tool, such as a paper clip, to be at least partially inserted therethrough to engage the ball latch 1604 and prevent it from retracting against the spring force during installation of the wearable member 2102.

While the covering component 2106 is shown covering much of the tip 2005 of the ball latch 1604, in exemplary embodiments, the covering component 2106 can have any convenient size, be symmetrical or non-symmetrical, have a circular profile or a strip profile to match one or more grooves 2112 formed in the surface of the ball latch 1604. In exemplary aspects, the wearable member 2102 is a plastic, such as polypropylene or polyethylene, though it may be any material that is wearable, with strength to last a desired amount of cycles and lower friction to facilitate smooth engagement with the strike. In other exemplary embodiments the wearable material is Acetal. In further exemplary embodiments, the wearable material is Delrin. In exemplary aspects, the wearable member 2102 is configured having a thickness or height above the ball latch 1604 to withstand a predetermined number of cycles, e.g., 25000 cycles (approximately 10 years of use). In further exemplary embodiments, the covering component 2106 has a mushroom shape that has an angle greater than 0.5 degrees, with a profile configured to cause impact forces to push the covering component 2106 down and in rather than up and out, thereby maintaining secure retention within the channel 2004. Further, in exemplary embodiments, the shape of the covering component 2106 can be larger near the center (at the channel 2004), tapering narrower towards the anticipated impact faces. This is because the majority of wear is due to drag on the ball latch 1604 relative to the strike plate. Wear increases in magnitude as the highest point of the ball latch 1604 contacts the strike plate due to the increase in pressure of the spring members 1808 (reaching a maximum force at that position). FIGS. 21D and 21E further illustrate an exemplary wearable member 2102, with FIG. 21D showing the wearable member 2102 as a separate component with fins or wings extending outward from a central body portion, and FIG. 21E showing the wearable member 2102 installed in the ball latch 1604 with a covering component sitting over the spherical tip of the ball latch 1604. FIG. 21F illustrates the ball latch assembly 2100 with the wearable member 2102 detached from the tip 2005 of the ball latch, showing the threaded member 1816 extending from the assembly and demonstrating the removable nature of the wearable member 2102 for replacement when worn.

Additionally, the wearable member 2102 shown in the tip 2005 of the ball latch 1604, in exemplary embodiments can be configured to contain within its body an indicating feature such that as wear progresses to a point of detriment to the ball latch 1604 the indicating feature visually alerts the user to replace the part. In exemplary aspects, the indicator feature is symmetrical or non-symmetrical, has a circular or tubular profile, or a strip profile that is co-radial to the surface of wearable member 2102. In other exemplary aspects, the indicator is situated at locations and to depths of wear where they would best provide an early visual alert to the user to replace the part.

In further exemplary embodiments, the covering component 2106 further includes a wear indicator. In exemplary aspects, this wear indicator may be colored, configured as a wear pin, overmolded on the covering component 2106 (in some embodiments in symmetrical form), such that there is a visual alert to prompt a homeowner or business operative to replace the wearable member 2102.

In further exemplary aspects, an overmolded wear pin set is provided in a symmetrical form so that however the wearable member 2102 is placed within the channel 2004, the data-based wear points show the indicator first.

In additional exemplary embodiments, an indicator pin positioned in the wearable member 2102 is positioned vertically (or approximately vertically) such that, while being essentially symmetrical in nature to wear, it indicates a need at a certain time to change the part from a different position, or to change the part overall. The indicator pin can be positioned at a certain height within the wearable member 2102, e.g., with reference to the height of material between the surface line and the over-molded point indication, as dependent upon the composition of and anticipated wearability of that wearable material, e.g., a plastic, thermoplastic, etc., material, which may also be determined via cycle testing.

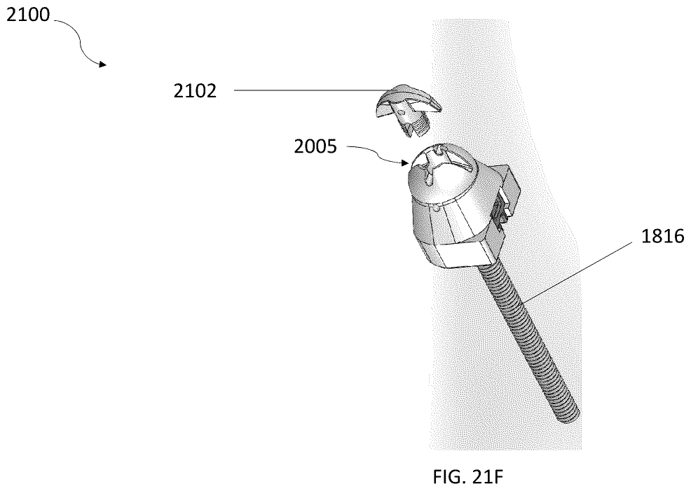

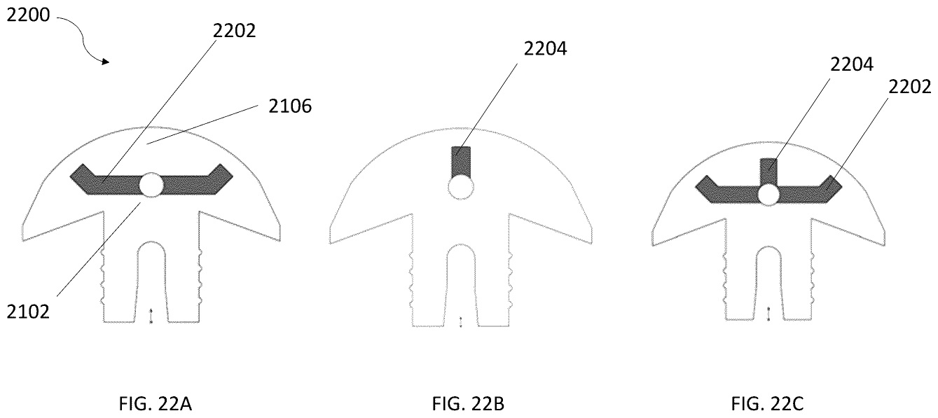

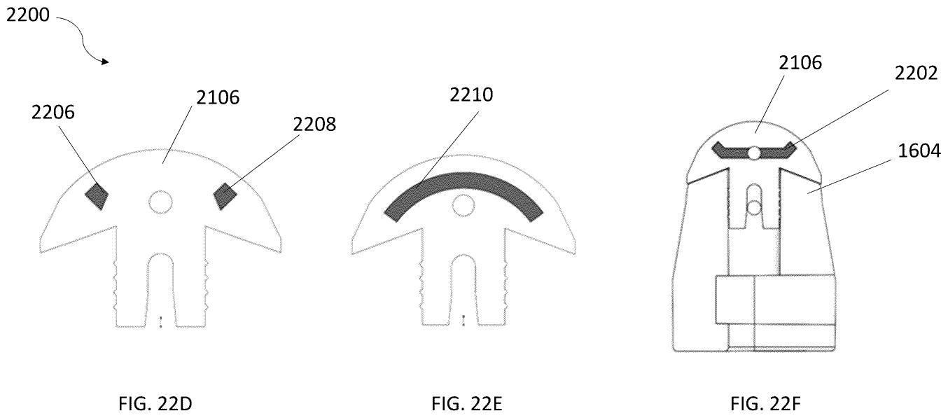

FIG. 22A illustrates, generally at 2200, a plan view of an exemplary wearable member 2102 including covering component 2106 that also includes a wear indicator 2202 in an exemplary symmetrical form with the wear indicator 2202 positioned symmetrically on each wing portion of the covering component 2106. FIG. 22B shows a plan view of a wearable member 2200 with a single wear pin 2204 positioned centrally on one side of the covering component 2106, providing a visual indication of wear progression as the wearable member 2200 is used over time. FIG. 22C shows a plan view of a combination of symmetrical outlier and wear indicators 2202 and a central wear pin 2204 for additional variation, advantageously providing wear indication on not just two, but possibly three points of wear (though it is noted that wear indicator aspects may be provided in more than three locations and could be symmetrical or asymmetrical, or only provided along with the covering component 2106 in a single direction).

FIG. 22D illustrates a covering component 2106 with plural discrete wear indicators 2206, 2208 positioned at different locations on the covering component 2106. It is noted that any number or sizes of wear indicators may be provided with the covering component 2106. FIG. 22E illustrates a wearable member 2200 with a half-moon wear indicator 2210 positioned as a curved element on the covering component 2106, though it is noted that any shape for such a wear indicator is contemplated herein. FIG. 22F shows a wearable member 2200 with a wear indicator installed over the tip of the ball latch 1604, with the covering component 2106 positioned symmetrically on the wing portions. It is noted that wear indicators could be symmetrical or asymmetrical, or only provided along with the covering component 2106 only in a single direction (e.g., only one wearable wing).

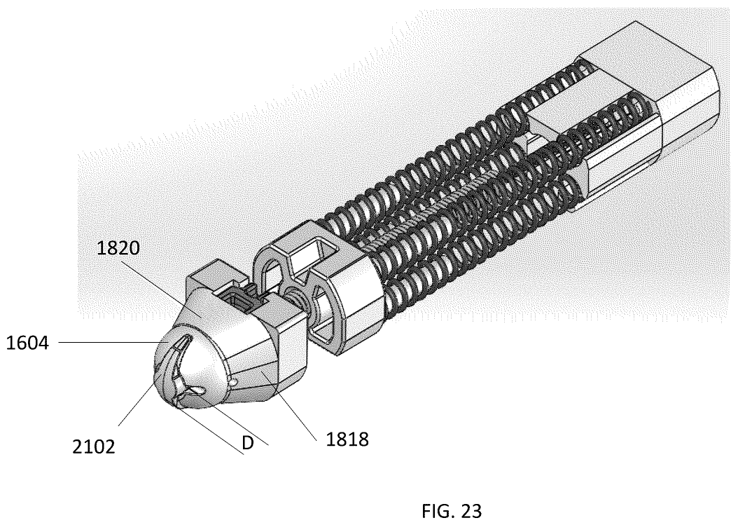

FIG. 23 is an additional perspective view of ball latch and cassette components, showing the assembled relationship between the ball latch 1604, the bolt 1820 with its blended angled sides 1818, and an installed wearable member 2102. The spherical shape of the ball latch 1604 combined with the blended angled sides 1818 of the bolt 1820 cooperate to allow the bolt 1820 to detent along a roller strike until enough pressure or force is applied to allow the latch to be retracted into the central case, facilitating smooth engagement and disengagement with a corresponding strike plate. As in FIG. 18, the exemplary embodiment also has an adjustable spring force mechanism allowing lowering or raising of the resistance of the spring force to open the door. FIG. 23 additionally shows an installed wearable member 2102 that protrudes a distance D from the tip of the wearable member.

Embodiments of the present disclosure presented above may be reflected in the following paragraphs:

Paragraph 1: A multipoint lock, comprising:
a cassette housed in a central case;
at least one auxiliary latch;
a latch drive hub; and
a deadbolt drive hub.

Paragraph 2: The multipoint lock of paragraph 1, wherein the cassette is removably housed in the central case.

Paragraph 3: The multipoint lock of paragraph 1, wherein the cassette includes a ball latch detent outwardly biased by a spring force in the cassette.

Paragraph 4: The multipoint lock of paragraph 4, wherein the spring force is adjustable.

Paragraph 5: The multipoint lock of paragraph 4, wherein the spring force comprises multiple springs disposed in the cassette.

Paragraph 6: The multipoint lock of paragraph 5, wherein the multiple springs have at least two different spring forces.

Paragraph 7: The multipoint lock of paragraph 4, wherein the spring force is non-linear.

Paragraph 8: The multipoint lock of paragraph 3, wherein the ball latch detent includes an aperture configured to receive a replaceable, wearable member protruding from a tip thereof.

Paragraph 9: The multipoint lock of paragraph 3, wherein in the ball latch detent includes an aperture configured to receive a replaceable, wearable member, further including a wear indicator within its shape, protruding from a head portion thereof.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. A multipoint lock, comprising:
a cassette housed in a central case;
at least one auxiliary latch;
a latch drive hub; and
a deadbolt drive hub.

2. The multipoint lock of claim 1, wherein the cassette is removably housed in the central case.

3. The multipoint lock of claim 1, wherein the cassette includes a ball latch detent outwardly biased by a spring force in the cassette.

4. The multipoint lock of claim 1, wherein the spring force is adjustable.

5. The multipoint lock of claim 4, wherein the spring force comprises multiple springs disposed in the cassette.

6. The multipoint lock of claim 5, wherein the multiple springs have at least two different spring forces.

7. The multipoint lock of claim 4, wherein the spring force is non-linear.

8. The multipoint lock of claim 3, wherein the ball latch detent includes an aperture configured to receive a replaceable, wearable member protruding from a tip thereof.

9. The multipoint lock of claim 3 where in the ball latch detent includes an aperture configured to receive a replaceable, wearable member, further including a wear indicator within its shape, protruding from a head portion thereof.

10. A cassette assembly for a multipoint lock, comprising:
a housing configured to be removably received within a central case of a mortise box;
a ball latch disposed at one end of the housing, the ball latch having a spherical head portion; and
a spring force mechanism disposed within the housing and configured to bias the ball latch outwardly.

11. The cassette assembly of claim 10, wherein the ball latch includes blended angled sides formed on a bolt extending from the spherical head portion.

12. The cassette assembly of claim 10, wherein the spring force mechanism comprises a plurality of spring members disposed around a threaded member.

13. The cassette assembly of claim 12, further comprising an adjustment block connected to the ball latch via the threaded member, wherein rotation of the threaded member translates the adjustment block to adjust compression of the plurality of spring members.

14. The cassette assembly of claim 12, further comprising a spring retainer positioned at an end of the housing opposite the ball latch, the spring retainer configured to retain the plurality of spring members.

15. The cassette assembly of claim 10, wherein the ball latch includes a channel extending through a tip thereof, the channel configured to receive a tool for adjustment of the spring force mechanism.

16. The cassette assembly of claim 15, wherein the ball latch includes a pocket configured to receive a head of the threaded member, the channel connecting to the pocket.

17. The cassette assembly of claim 10, further comprising a replaceable wearable member configured to be received within an aperture of the ball latch.

18. The cassette assembly of claim 17, wherein the wearable member includes ribs configured to engage interior walls of the aperture to retain the wearable member in place.

19. The cassette assembly of claim 17, wherein the wearable member includes a covering component configured to extend at least partially over the tip of the ball latch.

20. The cassette assembly of claim 17, wherein the wearable member includes a wear indicator configured to provide a visual alert when wear progresses to a predetermined level.
